(19) United States
(12) Patent Application Publication
(10) Pub. No.: US 2007/0030197 A1
(43) Pub. Date: Feb. 8, 2007

(54) Antenna Structure

(76) Inventors: Feng-Chi Eddie Tsai, Taipei Hsien (TW); Chia-Tien Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,364

(22) Filed: Nov. 21, 2005

(30) Foreign Application Priority Data
Aug. 8, 2005 (TW) 094126825

(51) Int. Cl. H01Q 1/38

(52) U.S. Cl. 343/700 MS; 343/702

(57) ABSTRACT

An antenna includes a ground portion, a radiating element, and an interconnecting element connected to the ground portion and the radiating element. The radiating element includes a first radiating trace including a turning point connected to a first segment and a second segment of the first radiating trace, and a second radiating trace connected to the second segment of the first radiating trace.

### BACKGROUND OF THE INVENTION

1. Field of the Invention

The invention provides an antenna, and more specifically, a small multi-frequency antenna.

2. Description of the Prior Art

In the prior art, an inverted F antenna is usually used to realize a radio signal switch.

As those skilled in the art know, the basic inverted F antenna includes a radiating element. One end of the radiating element connects with a ground portion, and the middle of the radiating element is used as the feeding point of the signal. The ground portion and the signal feeding point form two transverse portions of an F shape (The radiating element becomes the back of the F shape.). The length of the antenna has a relationship with a radiating frequency of transmitting and receiving. However, the simple inverted F antenna only supports a single-frequency for transmitting and receiving radio signals. It cannot integrate multiple frequencies for transmitting and receiving radio signals. The length of the radiating element is relatively long, so compact size requirements of the information industry cannot be met. In addition, U.S. Pat. No. 6,861,986 provides a kind of multiple-frequency application for an inverted F antenna, however, the antenna uses two ends in a straight line radiating element to radiate two frequencies. Thus, the size of the radiating element is not compact.

### SUMMARY OF THE INVENTION

It is therefore a primary objective of the claimed invention to provide a multiple-frequency antenna that can not only support multiple-frequency transmitting and receiving of radio signals, but that also has compact size without having an effect on the performance of antenna.

According to the claimed invention, the antenna includes a radiating element, an interconnecting element, and a ground portion. The radiating element comprises two radiating traces, wherein at least a radiating trace includes a turning point to subdivide the trace into a plurality of segments. Hence, the radiating element can be viewed as an element including a plurality of segments. An interconnecting element is connected to the ground portion and the radiating element. The interconnecting element is used to receive an input/output signal, and includes a plurality of turning points to subdivide the interconnecting element into a plurality of subsections. The segment of the radiating trace is opposite to the position of the interconnecting element and extends away from the grounded portion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 to 8 show a plurality of antennas of embodiments of the present invention.

### DETAILED DESCRIPTION

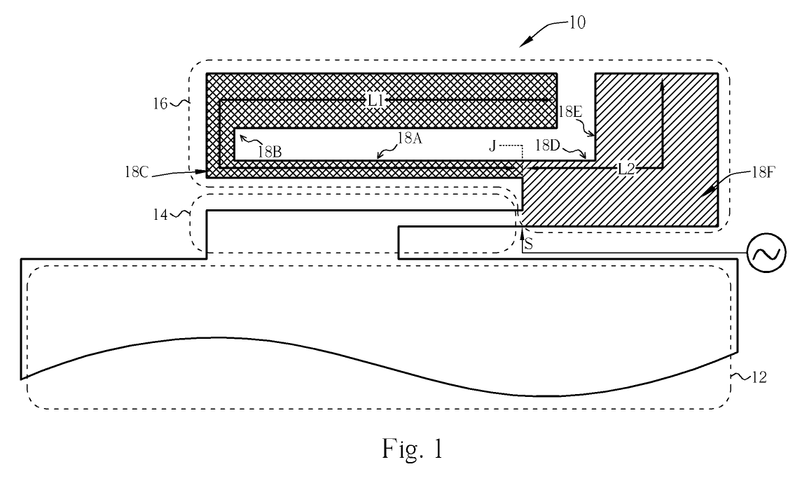

Please refer to FIG. 1. FIG. 1 shows an embodiment of the antenna 10 according to the present invention. The antenna 10 includes a ground portion 12, an interconnecting element 14, and a radiating element 16. Each component can be formed by an electrically conductive surface, for example, by a conductive layer in a printed circuit board. As FIG. 1 shows, the ground portion 12 is used to connect with ground, the radiating element 16 and the ground port 12 are separated but mutually connected by the interconnecting element 14 disposed between. The radiating element 16 is divided into two radiating traces, wherein a cross-hatched region is a first radiating trace L1, and a single-hatched region is a second radiating trace L2. The two radiating traces L1 and L2 use the interconnecting element 14 to connect with the ground portion 12. In the embodiment of FIG. 1, the interconnecting element 14 has two bent segments, so the signal can input to and output from the antenna 10 by one feeding point of signals.

In other words, a signal line is connected to feeding point S. As FIG. 1 shows, the two radiating traces L1 and L2 of the radiating element 16 both have bends. In the first radiating trace L1, the region parallel with the ground portion 12 is a second segment 18A, and the region extending above along a bended portion 18C is a first segment 18B. Similarly, in the second radiating trace L2, the portion parallel to the ground portion 12 is a third segment 18D, and the portion extending above along a bended portion 18F is a fourth segment 18E. Owing to the bent shape design of the radiating element of the invention, the size and the occupied volume of the radiating element is compact and efficient.

As FIG. 1 shows, based on the interconnecting portion J, the antenna 10 can resonate two different frequencies by means of the left element and the right element of the radiating element, and the antenna 10 of the invention can integrate the transmitting and receiving of signals. When realizing the antenna 10, the operating frequencies of the antenna 10 can be adjusted by changing the lengths of the radiating traces L1 and L2. From FIG. 1, we can see that the radiating traces L1 and L2 are bent in reverse directions, so that the invention has compact size radiating elements.

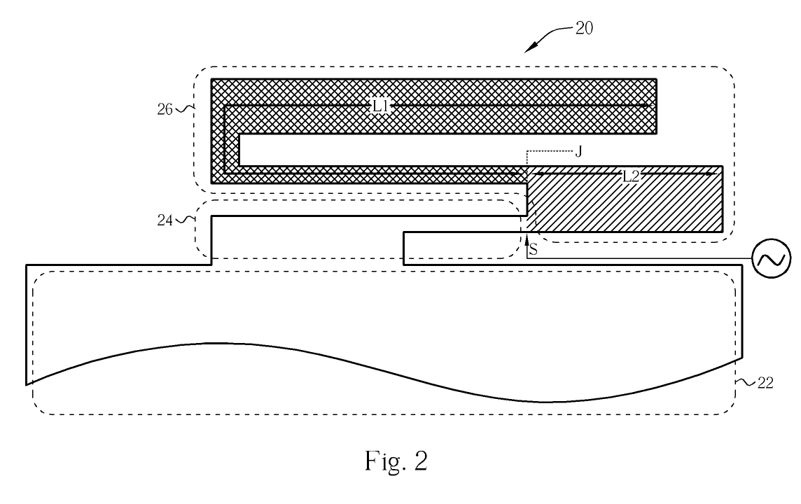

In the embodiment of the FIG. 1, the two radiating traces L1 and L2 of the radiating element 16 both have bent structure. However, the invention also provides an embodiment with one radiating trace bent. Please refer FIG. 2. FIG. 2 is an embodiment of an antenna 20 of the invention. Similar to the antenna 10 of FIG. 1, the antenna 20 of FIG. 2 also has ground portion 22, a bent interconnecting element 24, and a radiating element 26. But only the left radiating trace L1 (cross-hatched portion) of the antenna 20 forms a reverse-bent structure, the right radiating trace L2 (single-hatched portion) has a segment paralleling to the ground portion. The straight portion still has the effect of resonating, and the antenna 20 can resonate two frequencies.

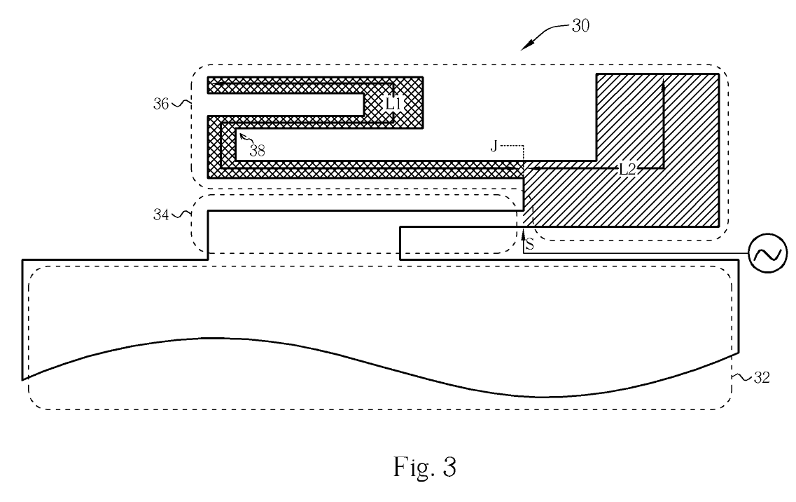

In the embodiment of FIG. 1, the first radiating trace L1 of the first radiating element 16 is bent into two sub-segments. However, according to the invention, each radiating trace can have more bended portions. Please refer to the embodiment of FIG. 3, which shows an antenna 30. Similar to the antenna 10 of FIG. 1, the antenna 30 also has a ground portion 32, an interconnecting element 34, and a radiating element 36. However, in the left radiating trace L1 (cross-hatched portion), a first element 38 is divided into four segments by three turning points. As FIG. 1 shows, the antenna 30 can radiate two kinds of different frequencies with radiating traces L1 and L2.

In the embodiments of FIG. 1 to FIG. 3, each segment is extending in an up direction, and is not extending in a down direction between a radiating element and ground portion. Besides, a width of each segment can be different. For example, in the embodiment of FIG. 1, the width of the segment 18D is larger than the width of the segment 18E. According to simulation and test, the antennas of FIG. 1 to FIG. 3 of the invention can all achieve omni-directional radiating field patterns, and have good bandwidth in the two radiating frequencies.

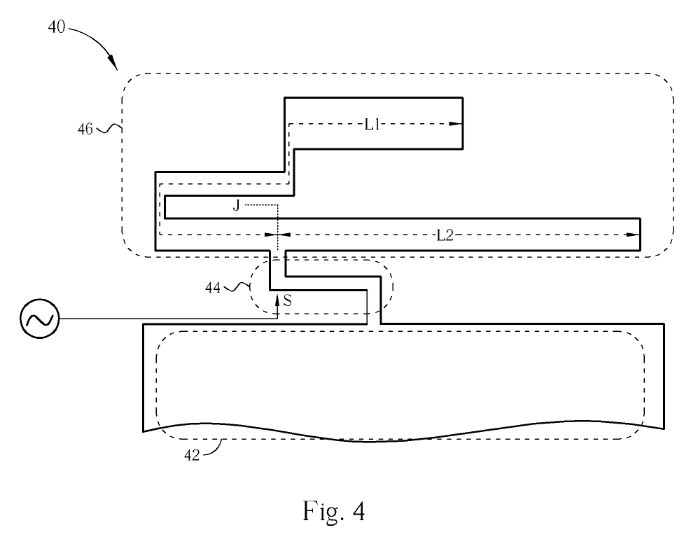

FIG. 4 shows another embodiment 40 of an antenna of the present invention. An antenna 40 includes a ground portion 42, an interconnecting element 44 and a radiating element 46. In this embodiment, the interconnecting element is bent into three segments by two turning points. The signal of a transmission line can be fed in from a feeding line. Based on an interconnecting portion J, the radiating element 48 can resonate two different frequencies by means of the left element L1 and the right element L2 of the radiating element 48.

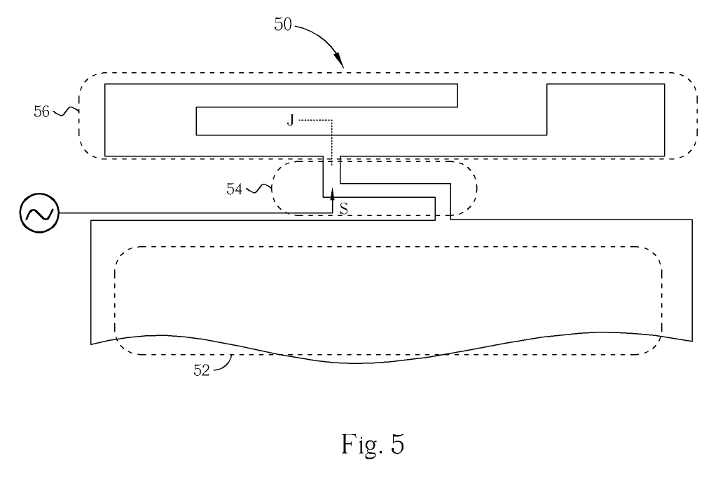

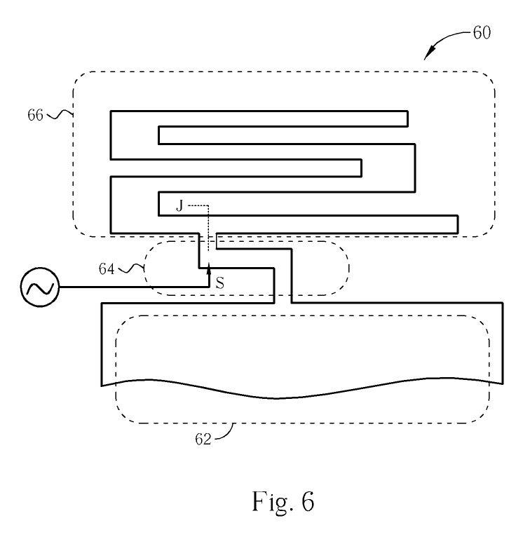

FIGS. 5 and 6 show two embodiments. Similar to the antenna 40 of FIG. 4, an antenna 50 of FIG. 5 includes a ground portion 52, an interconnecting element 54, and a radiating element 56. The two radiating traces of the radiating element 58 both have bended portions. An antenna 60 of FIG. 6 includes a ground portion 62, an interconnecting element 64 and a radiating element 66. The left radiating trace of the radiating element 66 has a plurality of turning points to subdivide the left radiating trace into a plurality of segments.

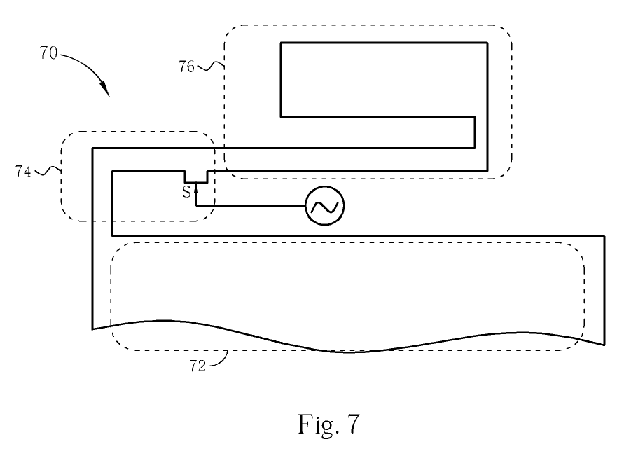

In FIG. 1 to FIG. 6, each antenna is designed for the aim of two frequencies. However, the spirit of the invention can also apply to a single-frequency inverted F antenna for reducing the size by way of bends. Regarding this kind of application, please refer FIG. 7, which shows an application of a single frequency antenna 60 of the invention. An antenna 70 includes a ground portion 72, an interconnecting element 74 and a radiating element 76. The right portion of the radiating element 76 is bent for compacting the size of the radiating element 76.

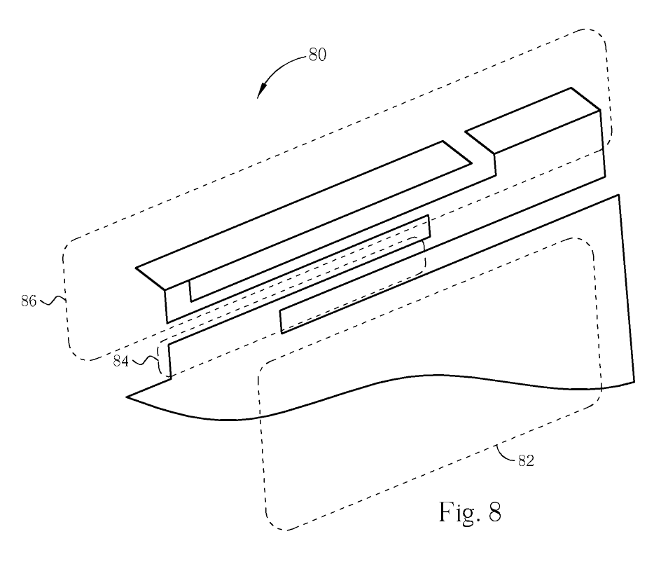

According to the invention, a ground portion, an interconnecting element, and a bent radiating element can be coplanar and, for example, formed in a printed circuit board. However, the antenna can also be of a three-dimensional and non-coplanar type. Please refer to FIG. 8, which shows another embodiment. A dual-band antenna 80 has a ground portion 82, an interconnecting element 84, and a radiating element 86. Two radiating traces of the radiating element 88 each have a structure of bent shape. It is worth mentioning that a part of a segment of the turning point is not coplanar with the ground portion 82 and forms an angle with the ground portion 82. This non-coplanar part makes the antenna 80 a three-dimensional antenna.

In summary, the antenna of the present invention has a bent radiating element which means that the radiating element is of compact size. Compared with the prior art, the antenna of the present invention can transmit and receive electromagnetic waves of multiple frequencies, has a compact size, has parameters that are not adversely influenced, achieves an omni-directional radiating field pattern, and has good bandwidth in each frequency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna comprising:
a ground portion;
a radiating element comprising:
a first radiating trace including a bended portion connected to a first segment and a second segment of the first radiating trace; and
a second radiating trace connected to the second segment of the first radiating trace; and
an interconnecting element connected to the ground portion and the radiating element.

2. The antenna of claim 1 wherein the interconnecting element includes at least one turning point to subdivide the interconnecting element into a plurality of subsections.

3. The antenna of claim 1 wherein the first segment of the first radiating trace extends away from the grounded portion.

4. The antenna of claim 1 wherein the first segment of the first radiating trace includes a turning point to subdivide the first radiating trace into a plurality of segments.

5. The antenna of claim 1 wherein the interconnecting element is connected to the first radiating trace and the second radiating trace.

6. The antenna of claim 1 wherein a surface of the first segment subtends an angle with a surface of the ground portion.

7. The antenna of claim 1 wherein the first radiating trace further includes a third segment bent from the first segment extending toward the second radiating trace.

8. The antenna of claim 1 wherein a width of the first segment is larger than a width of the second segment.

9. An antenna comprising:
a ground portion;
a radiating element comprising:
a first radiating trace including a first bended portion connected to a first segment and a second segment of the first radiating trace; and
a second radiating trace connected to the second segment of the first radiating trace, the second radiating trace includes a second bended portion connected to a third segment and a fourth segment of the second radiating trace; and
an interconnecting element connected to the ground portion and the radiating element.

10. The antenna of claim 9 wherein the third segment of the second radiating trace is connected to the second segment of the first radiating.

11. The antenna of claim 9 wherein the interconnecting element includes a first turning point to subdivide the interconnecting element into a plurality of segments.

12. The antenna of claim 9 wherein the fourth segment of the second radiating trace extends away from the ground portion.

13. The antenna of claim 9 wherein the fourth segment of the first radiating trace includes a second turning point to subdivide the first radiating trace into a plurality of segments.

14. The antenna of claim 9 wherein the interconnecting element is connected to the first radiating trace and the second radiating trace of the radiating element.

15. The antenna of claim 9 wherein a surface of the first segment subtends an angle with a surface of the ground portion.

16. The antenna of claim 9 wherein a surface of the fourth segment subtends an angle with a surface of the ground portion.

17. The antenna of claim 9 wherein a width of the fourth segment is larger than a width of the third segment.

18. An antenna comprising:
a ground portion;
a radiating element including a bended portion connected to a first segment and a second segment of the radiating element; and
an interconnecting element connected to the ground portion and the second segment of the radiating element;
wherein the first segment extends in a direction substantially parallel to the second segment.

19. The antenna of claim 18 wherein the first segment of the radiating element extends away from the ground portion.

20. The antenna of claim 18 wherein a surface of the first segment subtends an angle with a surface of the ground portion.

21. The antenna of claim 18 wherein a width of the first segment is larger than a width of the second segment.
